(19) United States
(12) Patent Application Publication
(10) Pub. No.: US 2009/0297305 A1
(43) Pub. Date: Dec. 3, 2009

(54) MATERIAL HANDLING DEVICE

(76) Inventor: Bob Autrey, Azle, TX (US)

Correspondence Address: K&L GATES LLP, 535 SMITHFIELD STREET, PITTSBURGH, PA, 15222, US

(21) Appl. No.: 12/130,078

(22) Filed: May 30, 2008

(51) Int. Cl. B65G 65/34; B60P 9/00

(52) U.S. Cl. 414/425; 414/462

(57) ABSTRACT

A material handling device may be configured to move and deliver a variety of materials throughout a worksite. The material handling device may be configured to be supported on a variety of vehicle platforms. Once the material handling device has been transported, the materials may be dumped from the material handling device. The dumping process may be initiated through the use of an actuator. The material handling device may comprise a dump body and a base frame. The dump body may be configured to be hingedly attached to the base frame. The base frame may comprise at least one first tube and at least one second tube. Both the first tube and the second tube may be configured to receive a fork and/or any other suitable support structure from a vehicle. The material handling device may comprise an actuator, a pump, and a reservoir which may be positioned within an actuator system area.

### BACKGROUND

1. Field of the Invention

The present invention generally relates to material handling and, more particularly, to a material handling device which can be mounted on or supported by a variety of vehicles.

2. Description of the Relevant Art

There often exists a need to move and deliver materials within a work site such as, for example, a construction site, an industrial site, a commercial site, a landscaping site, an agriculture site, a foundry, or a roofing site. These materials may include gravel, aggregates, rubble, sand, top soil, demolition materials, liquid solids, mortar, mulch, waste materials, and/or fertilizers, for example. In various circumstances, these materials may need to be carried up one or more stories in a building. Moving materials from the ground floor to a higher floor in a building using traditional methods, which can include wheelbarrows or other manual methods, can be strenuous and time consuming. What is needed is an improvement over the foregoing.

### SUMMARY

In at least one form of the invention, a material handling device may be configured to move and deliver a variety of materials such as, for example, gravel, aggregates, rubble, sand, top soil, demolition materials, liquid solids, mortar, mulch, waste materials, and/or fertilizers, throughout a work site such as, for example, a construction site, an industrial site, a commercial site, a landscaping site, an agriculture site, a foundry, or a roofing site. The material handling device may be configured to be supported on or by a variety of vehicle platforms such as, for example, pick-up trucks, fork lifts, and/or any other suitable vehicle platform. In various embodiments, the material handling device can be used to transport materials between two floors of a building, for example, and, in some circumstances, the material handling device may be able to transport materials to a roof of a building. In any event, once the materials have been transported, the materials may be removed from the material handling device. In at least one embodiment, this removal may be accomplished through the use of a dumping process. The dumping process may be initiated through the use of an actuator or through manual operation.

In various embodiments, the material handling device may comprise a dump body and a base frame. The base frame may comprise at least one first tube configured to receive a fork, a beam, and/or any other suitable support structure from a vehicle. The base frame may also comprise at least one second tube configured to receive a fork, a beam, and/or any other suitable support structure. In at least one embodiment, the first tube may extend in a direction which may be different than the direction in which a second tube extends. In certain embodiments, the material handling device may further comprise an actuator, pump, and/or reservoir, for example, which can be configured to move the dump body of the material handling device relative to the base frame. In at least one embodiment, one or more of the actuator, pump and reservoir may be retained and/or positioned within an actuator system area and may be positioned between two or more first tubes and/or two or more longitudinal members. In various embodiments, the pump may be powered by a source of power which may be controlled through a control source, wherein, in at least one embodiment, the control source may be configured to be operated remotely. The material handling device may also comprise a locking mechanism which may lock the dump body to the base frame in a non-dumping position. In at least one embodiment, the dump body can include a lifting lug configured to allow the material handling device to be lifted upwardly, for example, and moved within a work site.

This Summary is intended to briefly outline certain embodiments of the subject application. It should be understood that the subject application is not limited to the embodiments disclosed in this Summary, and is intended to cover modifications that are within its spirit and scope, as defined by the claims. It should be further understood that this Summary should not be read or construed in a manner that will act to narrow the scope of the claims.

### BRIEF DESCRIPTION OF THE FIGURES

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a perspective view of a material handling device in accordance with at least one embodiment of the present invention having a dump body shown in a down, or non-dumping, position;

FIG. 2 is a perspective view of the material handling device of FIG. 1 with the dump body shown in an up, or dumping, position;

FIG. 3 is a side view of the material handling device of FIG. 1;

FIG. 4 is an end view of the material handling device of FIG. 1;

FIG. 5 is a perspective view of an upper frame of the dump body of FIG. 1;

FIG. 6 is a perspective view of a base of the material handling device of FIG. 1 with an actuator shown in a down position;

FIG. 7 is a perspective view of the base of the material handling device of FIG. 6 with the actuator shown in an up position; and

FIG. 8 is a bottom view of the base of the material handling device.

Corresponding reference characters indicate corresponding parts throughout the several views. The exemplifications set out herein illustrate embodiments of the invention, in one form, and such exemplifications are not to be construed as limiting the scope of the invention in any manner.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those of ordinary skill in the art will understand that the devices and methods specifically described herein and illustrated in the accompanying drawings are non-limiting exemplary embodiments and that the scope of the various embodiments of the present invention is defined solely by the claims. The features illustrated or described in connection with one exemplary embodiment may be combined with the features of other embodiments. Such modifications and variations are intended to be included within the scope of the present invention.

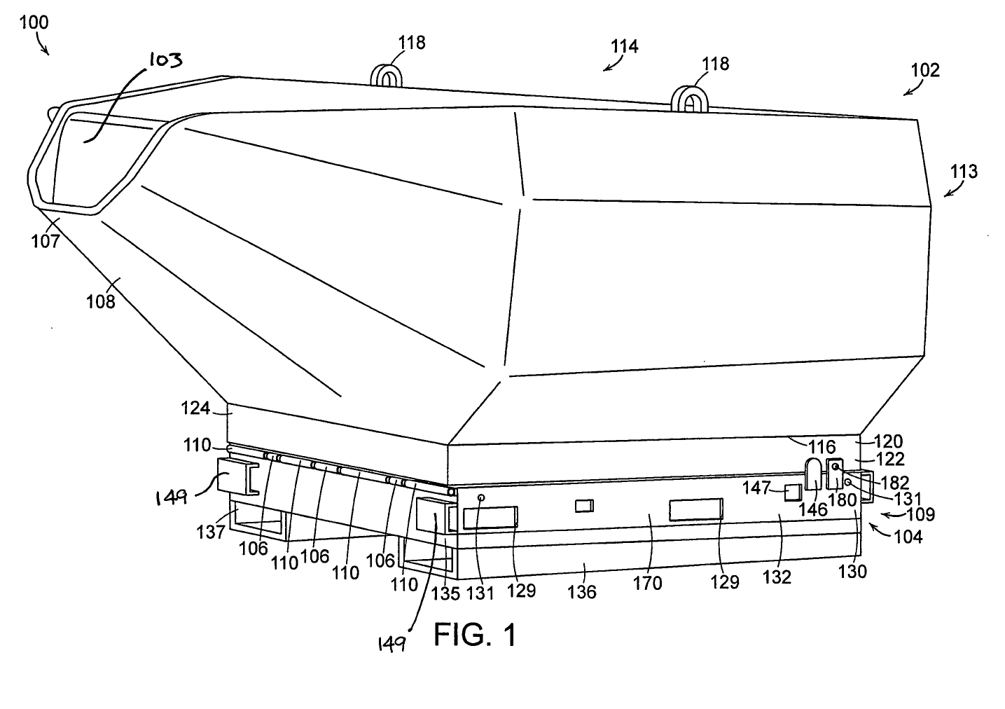

In various embodiments, a material handling device in accordance with the present invention can include a material handling device 100. As shown in FIGS. 1-4, the material handling device 100 may comprise a tub 102 (e.g., a dump body portion) and a base 104. The tub 102 and/or base 104 may comprise one or more plates, channels, beams, round tubes, square tubes, and/or any member having a suitable shape. The tub 102 and the base 104 may be fabricated from steel, aluminum, composite materials, and/or any other suitable material.

In at least one embodiment, materials may be placed in the tub 102 of the material handling device 100 such that they may be transported by the material handling device 100. The material handling device 100 may be transported using a variety of vehicles which may include a pick-up truck, a fork lift, or any other suitable vehicle platform. In some circumstances, the materials may be transferred to various locations in a work site including to an elevated floor of a building or a roof of a building by using the lifting capabilities of a fork lift, or any other suitable lifting vehicle. In various circumstances, the material handling device 100 can be used to transport and dump a broad range of materials. Such materials may include gravel, aggregates, rubble, sand, top soil, demolition materials, liquid solids, mortar, mulch, waste materials, and/or fertilizers, for example. In view of the above, the material handling device may be used in a variety of applications including construction, industrial and commercial uses, landscaping, agriculture, foundry and mill uses, and/or roofing applications, for example. In various embodiments, the material handling device 100 may have capacities both in terms of volume and weight. For example, in at least one embodiment, the material handling device may have a capacity of two cubic yards and/or 10,000 lbs.

In various embodiments, as mentioned above, the material handling device 100 may be transported within the worksite using a forklift and/or any other suitable lifting vehicle. The material handling device 100 may be configured to allow the forks of a forklift and/or any other suitable support member of any other suitable vehicle to be inserted into tubes, for example, located on the base 104. Once the forks, and/or support members, have been inserted into the tubes, the forklift, for example, may raise the material handling device 100 to a suitable height for transportation and then transport the material handling device 100. In various embodiments, the forklift and/or other suitable lifting device may raise or lower the material handling device 100 to a height which corresponds to an appropriate dumping location. For example, the forklift may raise the material handling device 100 to a roof of a building and then dump the material handling device's 100 contents onto the roof for a roofing application. In another example, a suitable lifting device may lower the material handling device 100 to dump the material handling device's 100 contents into a ditch or trench. As can be seen from the above examples, the use of a forklift or any other suitable lifting device may allow for flexibility and convenience in dumping the contents of the material handling device 100 in a desired location.

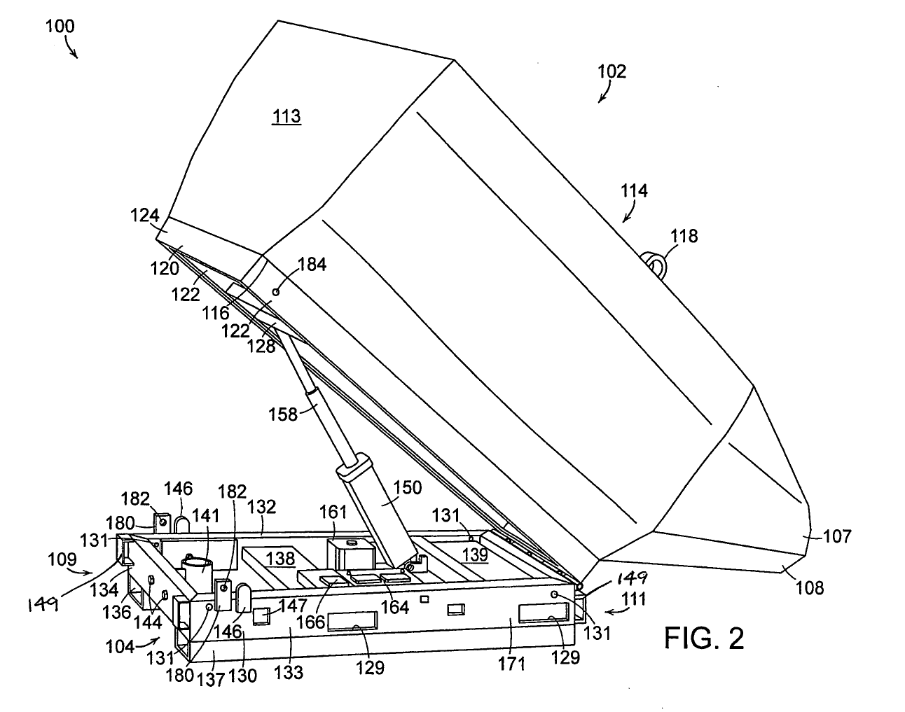

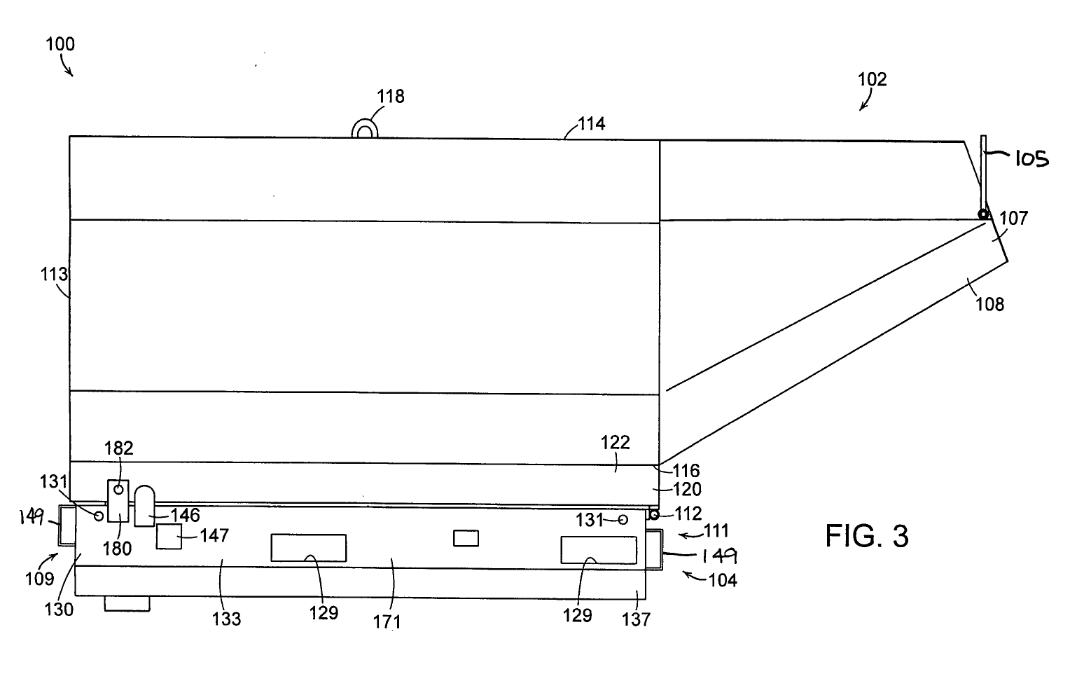

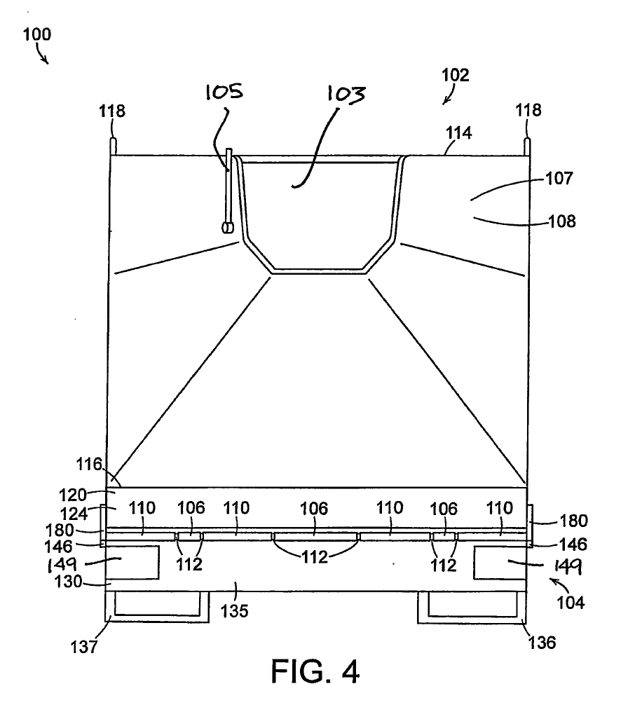

Once the materials have been transported to their desired location, the tub 102 of the material handling device 100 may be moved relative to the base 104 to dump the materials from the tub 102. Such a dumping motion may allow the materials in the tub 102 to be easily removed from the material handling device 100. In various embodiments, the dumping motion of the tub 102 may be achieved through manual movement of the tub 102 about a pivot axis. In at least one embodiment, referring to FIG. 2, the dumping motion can be achieved through a mechanical and/or electro-mechanical system which can include, for example, an actuator 150 configured to move the tub 102 relative to base 104 as described below. In certain embodiments, referring to FIGS. 3 and 4, tub 102 can include a splash gate 103 pivotably mounted thereto wherein, in at least one embodiment, splash gate 103 can be configured to prevent, or at least inhibit, the materials within tub 102 from escaping therefrom. In at least one such embodiment, tub 102 can further include handle 105 which can be used to rotate splash gate 103 into a position such that it will not impede, or at least substantially impede, the flow of materials through the chute 108 of tub 102.

According to various embodiments, referring to FIG. 1, the tub 102 may comprise a dump end 107 and a backwall 113. The tub 102 may also comprise a top portion 114 and a bottom portion 116. The bottom portion 116 of the tub 102 may be securely retained upon and/or integral with a support frame 120 which can provide structural support and/or stability to the tub 102. In various embodiments, although not illustrated, the upper frame 120 may be welded to the bottom 116 of the tub 102. In some embodiments, the upper frame 120 may be secured to the bottom 116 with bolts and/or other suitable fastening elements such as screws, nails, pins, or rivets, for example.

In various embodiments, the tub 102 may be moveably attached to the base 104 such that the tub 102 can be moved relative to the base 104 between a dumping position and a non-dumping position. As shown in FIGS. 1-4, the upper frame 120 of the tub 102 may be hingedly retained to the base 104. In at least one such embodiment, a first hinge portion may be mounted to the base 104 and a second hinge portion may be mounted to the tub 102 through the use of a hinge arrangement which may comprise one or more receptacles and one or more pins. The upper frame 120 may comprise at least one upper frame pin receptacle 106 which may be welded, and/or secured in another suitable manner, to the upper frame 120 at or near the dump end 107 of the tub 102 just below a chute 108 portion of the tub 102. In at least one embodiment, the upper frame 120 may comprise three upper frame pin receptacles 106. The base 104 may also comprise at least one lower frame pin receptacle 110 which may be welded, and/or secured in another suitable manner, to the base 104 on a first end 111 of the base 104. In at least one embodiment, the base 104 may comprise four lower frame pin receptacles 110 which can be aligned, or at least substantially aligned, with pin receptacles 106. The at least one upper frame pin receptacle 106 may be configured to be hingedly retained to the at least one lower frame pin receptacle 110 through the use of one or more pins 112 (FIG. 3) which can be inserted through apertures defined by pin receptacles 106 and 110, for example.

In various embodiments, referring to FIG. 2, the upper frame 120 and the tub 102 may be configured to rotate about the pin assembly during the dumping process. As mentioned earlier, the dumping process may be initiated through manual movement of the tub 102 or through a mechanical process such as the actuation of the actuator 150. In a manual dumping process, an operator may apply a force to the backwall 113 of the tub 102 thus causing the tub 102 to rotate about the hinge arrangement. In a mechanical dumping process, as described in greater detail below, the operator may actuate the actuator 150 which may cause the tub 102 to rotate about the hinge arrangement.

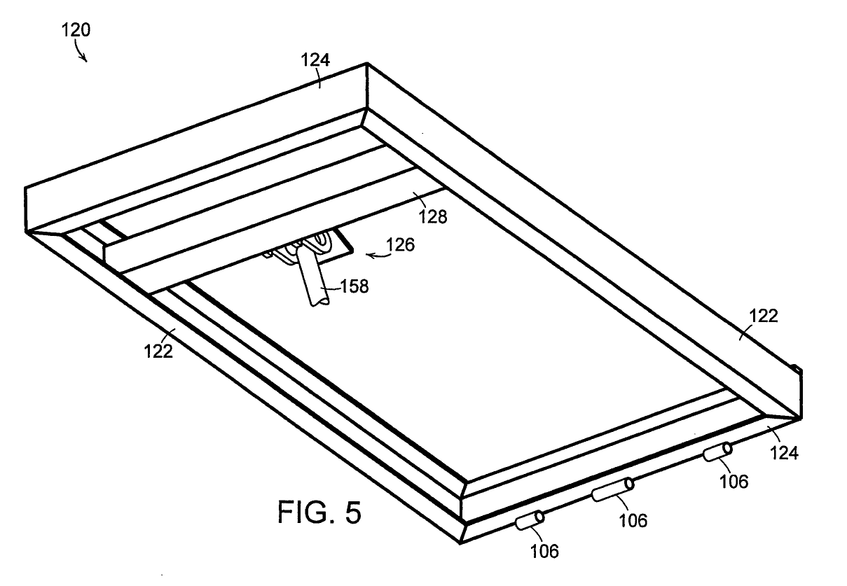

In various embodiments, referring to FIG. 5, the upper frame 120 which supports the tub 102 may have a rectangular, or at least substantially rectangular, shape. In other various embodiments, the upper frame 120 may have any other suitable shape which may include a square shape, an elliptical shape, and/or a circular shape, for example. In at least one embodiment, as shown in FIG. 5, the upper frame 120 may comprise two upper frame longitudinal members 122 and two upper frame latitudinal members 124. The two upper frame longitudinal members 122 may be orthogonal, or at least substantially orthogonal, to the two upper frame latitudinal members 124. The upper frame longitudinal members 122 and the upper frame latitudinal members 124 may be fabricated from steel, aluminum, composite materials, and/or any other suitable material. In some embodiments, longitudinal members 122 and latitudinal members 124 may be welded and/or fastened together such that, in at least one embodiment, members 122 and 124 are immovable, or at least substantially immovable, with respect to each other.

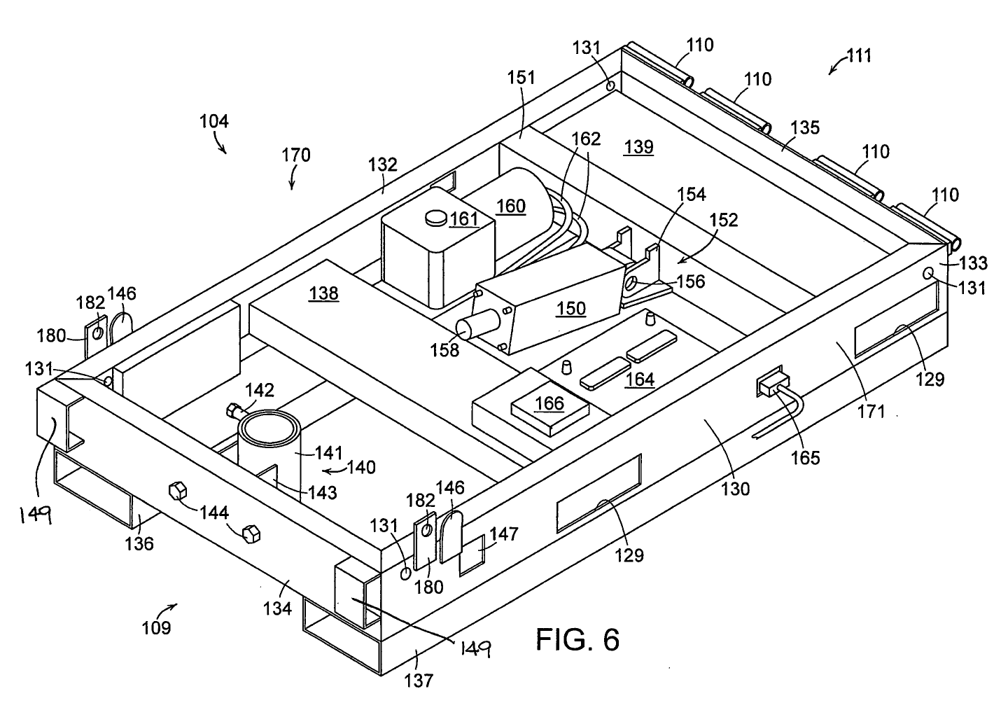

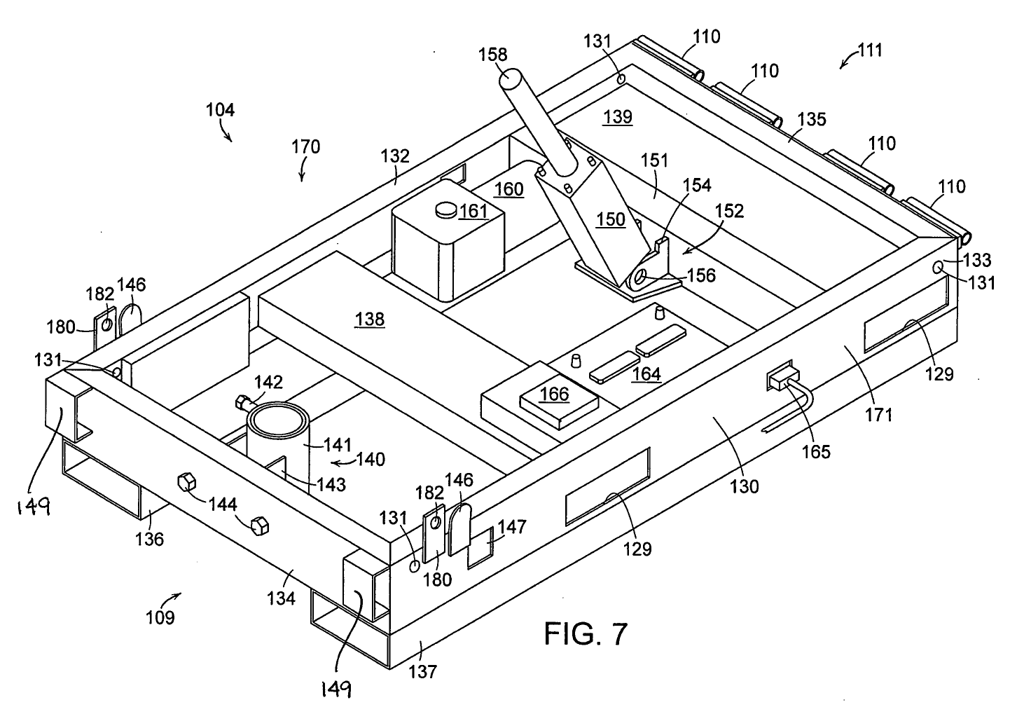

As shown in FIGS. 6-7, the base 104 of the material handling device 100 may have a rectangular, or at least substantially rectangular, shape. In various other embodiments, the base 104 may have any other suitable shape which may include a square shape, an elliptical shape, and/or a circular shape, for example. In various embodiments, the shape of the base 104 may correspond, or at least substantially correspond, to the shape of the upper frame 120. In various embodiments, a lower frame 130 of the base 104 may comprise a first longitudinal member 132 and a second longitudinal member 133 which may extend along the length of the base 104. The first longitudinal member 132 and/or the second longitudinal member 133 may comprise one or more channels, beams, round tubes, square tubes, and/or any member having a suitable shape. The first longitudinal member 132 and the second longitudinal member 133 may be fabricated from steel, aluminum, composite materials, and/or any other suitable material.

Referring to FIGS. 6-7, the lower frame 130 may also comprise a first latitudinal member 134 and a second latitudinal member 135 which may extend orthogonally, or at least substantially orthogonal, to the first longitudinal member 132 and the second longitudinal member 133. Similar to the above, the first latitudinal member 134 and the second latitudinal member 135 may comprise one or more channels, beams, round tubes, square tubes, and/or any member having a suitable shape. The first longitudinal member 132 and the second longitudinal member 133 may be fabricated from steel, aluminum, composite materials such as carbon fiber or carbon fiber reinforced plastic, and/or any other suitable material. In various embodiments, the first longitudinal member 132 and the second longitudinal member 133 may be connected by the first latitudinal member 135 at or near the first end 111 of the base 104 and may also be connected by the second latitudinal member 134 at or near the second end 109 of the base. The longitudinal members 132, 133 may be welded, fastened, and/or secured in any other suitable manner to the latitudinal members 134, 135 such that, in at least one embodiment, members 132, 133, 134, and 135 are immovable, or at least substantially immovable, with respect to each other.

In various embodiments, the lower frame 130 may also comprise at least one tube configured to receive a support member therein which may be placed in any suitable location on the lower frame 130. For example, returning to FIG. 4, the tubes may substantially run along the longitudinal direction of the lower frame 130 or the latitudinal direction of the lower frame 130. In at least one embodiment, referring to FIG. 6, the lower frame 130 may comprise a first latitudinal tube 138 and a second latitudinal tube 139. The first latitudinal tube 138 and the second latitudinal tube 139 may span the lower frame 130 in the latitudinal direction and, in some embodiments, connect the first longitudinal member 132 and the second longitudinal member 133. In at least one embodiment, members 132, 133 and tubes 138, 139 may be connected in an orthogonal, or at least substantially orthogonal arrangement. In at least one embodiment, tubes 138, 139 may be connected to the first and second longitudinal members 132, 133 at points where corresponding slots 129 are provided in the first and second longitudinal members 132, 133. In various embodiments, the tubes 138, 139 may comprise one or more channels, round tubes, square tubes, and/or any other suitable member configuration and the term “tube” as used herein shall include such configurations among others. The tubes 138, 139 may be fabricated from steel, aluminum, composite materials, and/or any other suitable material.

Further to the above, tubes 138, 139 may be configured to receive the forks and/or support beams, for example, of a fork lift and/or any other suitable lifting device. In various circumstances, the forks or support members can be inserted into the tubes 138, 139 such that, when the forks or support members are lifted upwardly, the fork and/or support members can contact a top surface of the tubes 138, 139 and lift the material handling device 100 upwardly. In various embodiments, the tubes 138, 139, owing to their open ends, may receive forks and/or any other suitable supporting section from either a right end 170 or a left end 171 of the lower frame 130. Advantageously, such an arrangement can allow the material handling device 100 to be approached from a plurality of directions. In at least one embodiment, the tubes 138, 139 may be located near the first end 111 of the base 104. In various embodiments, the tubes 138, 139 may be located near the second end 109 of the base 104 and/or any other suitable location within the lower frame 130.

In various embodiments, as mentioned above, the tubes may run along the longitudinal direction of the base 104 and/or the latitudinal direction of the base 104. In at least one embodiment, referring to FIG. 6, the base 104 may comprise a first longitudinal tube 136 and a second longitudinal tube 137. The first longitudinal tube 136 and the second longitudinal tube 137 may be located below the lower frame 130, for example, and extend along the longitudinal direction of the base 104. The tubes 136, 137 may comprise one or more channels, round tubes, square tubes, and/or any member having a suitable shape. As before, the term “tube” as used herein shall include such configurations among others. The tubes 136, 137 may be fabricated from steel, aluminum, composite materials, and/or any other suitable material. In various embodiments, referring to FIG. 2, these tubes 136, 137 may receive forks and/or any other suitable supporting members through openings at the second end 109 of the base 104. Similarly, the tubes 136, 137 may be configured to receive forks and/or any other suitable supporting members through openings adjacent to the first end 111 of the base 104. In various embodiments, the longitudinal tubes 136, 137 may extend in a direction which is orthogonal, or at least substantially orthogonal, to the latitudinal tubes 138, 139. In some embodiments, the tubes 136, 137 can extend in a direction which is transverse and/or skew to the tubes 138, 139.

In various embodiments, as mentioned above, the material handling device 100 can include a system for moving the tub 102 relative to the base 104. In at least one embodiment, referring to FIG. 6, the base 104 may be configured to support the actuator 150 wherein the actuator 150 may be one of a hydraulic cylinder, a pneumatic cylinder, or any other suitable cylinder, for example. In at least one embodiment, the actuator 150 may be hingedly retained on a support member 151 of the base 104 on one end with an actuator retaining bracket assembly 152 which may comprise a retaining bracket 154 and a retaining pin 156. Referring again to FIG. 5, the distal end of the piston rod 158 of the actuator may be hingedly retained to the upper frame 120 using an upper frame piston rod retaining assembly 126 which may be mounted on an upper frame assembly connector member 128.

In at least one embodiment, as outlined above, the piston 150 can be extended to move the tub 102 relative to the base 104. In various embodiments, the piston 150 can be extended by a hydraulic system, a pneumatic system and/or any other suitable system. In various embodiments, referring to FIG. 6, an actuation system can include a pump 160 (e.g., a hydraulic pump) which can supply a pressurized fluid to the piston 150 to move the piston rod 158. The pump 160 may be fluidly connected to a reservoir 161 (e.g., a hydraulic reservoir) through the use of hoses 162 (e.g., hydraulic hoses). In use, the pump 160 may be configured to pump fluid from the reservoir 161 to the actuator 150. In such circumstances, the actuator 150 may be actuated from a down position, as shown in FIG. 6, to an up position, as shown in FIG. 7, by pumping fluid into the actuator 150. More particularly, by pumping fluid into the actuator 150, the piston rod 158 may be forced outwardly from the actuator 150 into an extended or up position. In various embodiments, the piston rod 158 may be extended along an axis that extends along the length of the actuator between the actuator retaining bracket assembly 152 and the upper frame piston rod retaining assembly 126. As the tub 102 may be hingedly retained to the base 104 at the hinge assembly, the tub 102 may be forced to rotate about the hinge assembly to a dump position as the piston rod 158 is extended. As a result, as the distal end of the piston rod 158 extends outwardly along the axis, the piston rod 158 may cause the tub 102 to dump the contents thereof. Thereafter, the tub 102 may be retracted into a down position when the piston rod 158 is retracted into its retracted position.

In various embodiments, the material handling device 100, for example, can include a power source 164 mounted thereto. In at least one embodiment, the power source 164 may be operably connected to the pump 160 to supply the pump 160 with sufficient power to move the piston rod 158 as described above. The power source 164 may be a battery (e.g., a 12 volt battery) which may, in some embodiments, be recharged through the use of a power source recharging module 165. In various embodiments, the power source recharging module 165 may be configured to recharge the power source 164 or may operate the pump 160 as a separate power source. In at least one embodiment, the pump 160, hoses 162, reservoir 161, actuator 150, and/or power source 164 may be contained within, or at least substantially contained within, the area formed by the first longitudinal member 132, the second longitudinal member 133, the first latitudinal tube 138 and the second latitudinal tube 139. In such embodiments, the members 132, 133 and the tubes 138, 139 can protect the pump 160, hoses 162, reservoir 161, actuator 150, and/or power source 164 from damage, for example.

In at least one embodiment, the power source 164 may be activated through the use of a wireless remote module 166 (e.g., a low voltage 12 volt wireless remote control) which may be engaged through any suitable wireless device such as a wireless remote control, personal data assistant (PDA), wireless e-mail device, cellular phone, pager, or any other programmable device configured to transmit and/or receive data. In various embodiments, the wireless remote module 166 may be retained to the first latitudinal tube 138, the second latitudinal tube 139, and/or any other suitable location on the base 104. Such a wireless system may allow for the material handling device 100 to be operated while the operator of the material handling device is located in a remote position relative to the material handling device 100. For example, the material handling device 100 may be mounted to the forks of a fork lift and raised to a second level of a building and may still be operated, or dumped, from ground level by the operator. In an alternative embodiment, the power source 164 may be activated through the use of a wired remote. In various embodiments, material handling device 100 can further include a kill switch, and/or control panel, which, in certain embodiments, can be manually operated. The kill switch, for example, can be located in any suitable location on device 100 and, in at least one embodiment, the kill switch can be positioned within aperture 147 in longitudinal member 132. Positioning the kill switch, for example, in aperture 147 can prevent, or at least reduce the possibility of, the kill switch from being accidentally actuated.

As discussed earlier, the distal end of the piston rod 158 may be hingedly retained to the upper frame 120 using the upper frame piston rod retaining assembly 126, for example. When the piston rod 158 is extended from a retracted, or down, position to an extended, or up, position, the piston rod 158 may cause the tub 102 and the upper frame 120 to rotate about the hinge connecting the tub 102 and the base 104 such that the contents within the tub 102 can flow from the chute 108 of the dump portion 107. For example, the material handling device 100 can be moved between a non-dumping position (or down position) as illustrated in FIG. 1 and a dump position (or up position) as illustrated in FIG. 2. Correspondingly, the position of the actuator 150 is shown in a retracted position (or down position) in FIG. 6 and in an extended position (or dump position) in FIG. 7. In various embodiments, when the tub 102 is at or near the down position, the tub 102 may engage tub placement guides 146 which may limit lateral movement of the tub 102.

The material handling device 100 may be configured to be supported upon a variety of vehicles. In various embodiments, in order to retain the material handling device 100 on a bed and/or any other suitable structure of a vehicle, such as a truck, for example, the operator may use a lock down assembly 140 as shown in FIGS. 6-7. In certain embodiments, the lock down assembly 140 may comprise a lock down tube 141 and a lock down bolt 142. The lockdown tube 141 may comprise a hollow tube with a circular cross-section (as shown), a square cross-section, and/or any other suitable cross-section. In certain embodiments, the lockdown tube 141 may extend from, or be retained near, the second end 109 of the base 104 via a lockdown bracket 143, for example, which may be secured to the first latitudinal member 134 through the use of bolts 144, or any other suitable fastening member. In various embodiments, the bed of the truck, for example, may have a post and/or any other suitable member (not shown) extending therefrom that corresponds to the lockdown tube 141 of the base 104. In at least one embodiment, the post, for example, may extend from, or be retained to, the bed of the truck, for example, through welds and/or another suitable retaining method. In some embodiments, the post can include a trailer ball which can be the same as, or similar to, trailer balls found in many typical trailer hitch arrangements. In use, the post, for example, may be inserted into, or otherwise engaged with, the lockdown tube 141 when the material handling device 100 is placed upon the bed of a truck, for example. In any event, the lockdown tube 141 may have a lockdown bolt, or bolts, 142 which may be positioned within one or more apertures in the lockdown tube 141 and the post to retain the post to the lockdown tube 141. In various embodiments, in addition to or in lieu of the above, a material handling device can include any suitable lockdown assembly for retaining the material handling device on a bed and/or any other suitable structure of a vehicle, for example. In various embodiments, the material handling device 100 can further include one or more tie-down pockets 149 which can be configured to receive one or more ropes, chains, and/or any other suitable devices, such as boomer chains, for example, which can be used to secure material handling device 100 to the bed of a truck, for example.

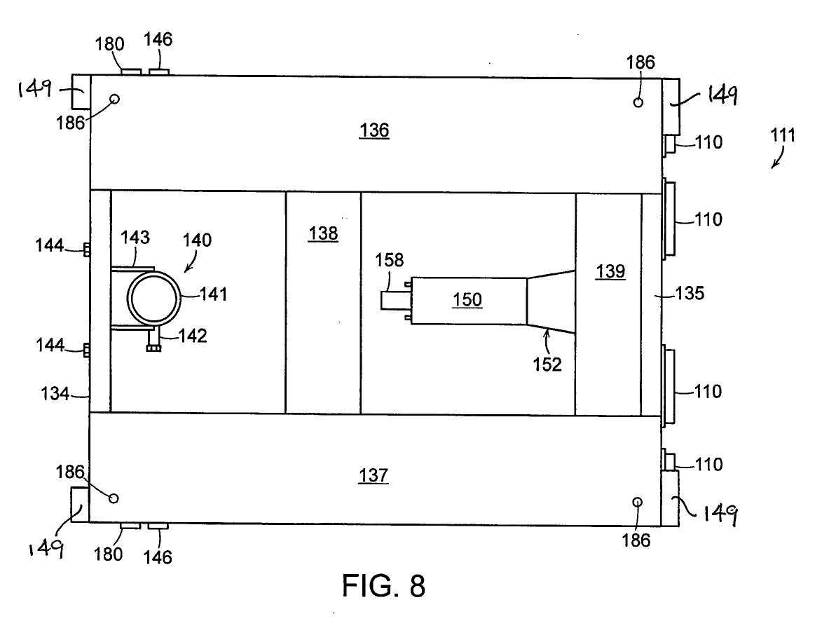

As already discussed, the tubes 136, 137, 138, 139 may allow a variety of vehicles with fork attachments (e.g., a fork truck, a skid steer loader, etc.) and/or any other suitable supporting section to pick up, or otherwise move, the material handling device 100. The material handling device may also be supported upon a variety of other vehicle platforms. For example, the material handling device 100 may be configured to be retained to a trailer, a self-contained rolling base, and/or other suitable platform. Furthermore, the material handling device 100 may be configured to be retained to a pickup truck, a flatbed truck, and/or any other suitable vehicle. In various embodiments, the material handling device 100 may be retained to such vehicle platforms, for example, through the use of bolts, screws, pin arrangements, welding, and/or any other suitable arrangement for fastening the material handling device 100 to a vehicle platform. In certain embodiments, the material handling device 100 may be retained to the vehicle platform through the use of bolts and/or any other suitable fastening member which can be inserted into the pin holes 131 in the base 104 and a corresponding arrangement of pin holes on the vehicle platform, for example. In various embodiments, the pin holes 131 may be found in the longitudinal members 132, 133, the latitudinal members 134, 135 (not shown), and/or any other suitable portion of the material handling device 100. In various embodiments, referring to FIG. 8, the tubes 136, 137, for example, can include bottom pin holes 186 for retaining the material handling device 100 to any suitable vehicle platform. In various embodiments, one or more of the pin holes 131 and pin holes 186 may be used at the same time to retain the material handling device 100 to a vehicle platform. Although not illustrated, pin holes be found in any suitable location in the base 104, for example, and/or any other suitable portion of the material handling device 100.

As shown in FIGS. 1-3, the material handling device 100 may be equipped with lifting lugs, such as lifting lugs 118, for example, which can be utilized to assist in placing the material handling device upon a truck bed, a trailer, or other suitable platform. In various embodiments, the lifting lugs 118 may be located on the top 114 of the tub 102 and may be configured to be used in conjunction with a suitable lifting device, such as a mobile crane or a fixed crane, for example. The lifting lugs 118 may be welded, bolted, and/or fastened in any suitable manner to the top 114 of the tub 102. The placement of the lifting lugs 118 may be determined using the center of mass of the material handling device 100. In at least one embodiment, the lifting lugs 118 may be positioned along a vertical axis extending through the center of mass of the material handling device 100, for example, when the tub 102 is empty, when the tub 102 is full, and/or under any other suitable circumstance. In at least one embodiment, the lifting lugs 118 may be placed above the center of mass of the material handling device 100 at or near the top 114 of the tub 102. In certain embodiments, base 104 can include one or more lifting lugs extending therefrom and/or mounted thereto. In at least one such embodiment, a crane, or other suitable lifting device, can be used to lift and/or suspend the material handling device above the ground via base 104. In certain circumstances, the tub 102 can be rotated relative to base 104 while the material handling device is suspended.

During periods of time when the operator of the material handling device does not want the tub 102 of the material handling device 100 to rotate about the hinge assembly as described above, the operator may use a lock down mechanism which retains the tub 102 to the base 104. In such embodiments, the lockdown mechanism may be used to prevent, or at least substantially limit, movement of the tub 102 relative to the base 104. The lock down mechanism may be particularly useful when the material handling device 100 is moved from a vehicle (e.g., a fork truck) to another vehicle (e.g., a pick-up truck) and/or when the material handling device 100 is lifted by the lugs 118, for example. In various embodiments, referring to FIGS. 1-3, the lock down mechanism may include lock down plates 180 extending from the base 104 where the plates 180 can include plate holes 182. The lockdown mechanism can also include corresponding lock down holes 184 in the tub 102 and/or upper frame 120, for example. In various embodiments, the lock down plates 180 may be secured to the base 104 through welding, bolting, riveting or any other suitable fastening or joining method. In use, the plate holes 182 may be substantially aligned with the lock down holes 184 when the tub is in a non-dumping position, for example. When the plate holes 182 and the lock down holes 184 are substantially aligned, each set of holes 182, 184 may be configured to receive a bolt, a post, a rivet and/or any other suitable member which can lock the tub 102 to the base 104 and thus prevent the tub 102 from hingedly moving, or at least substantially moving, relative to the base 104 about the hinge assembly. In at least one embodiment, a lockdown plate 180 and a lock down hole 184 may only be found on one side of the base 104. In certain embodiments, one or more lockdown plates 180 can be mounted to and/or extend from latitudinal member 134 wherein the one or more lockdown plates 180 can be, in some embodiments, located intermediate fasteners 144, for example. In any event, the material handling device 100 can include any suitable amount or arrangement of plates 180, plate holes 182, and/or lock down holes 184. In certain embodiments, one or more lockdown plates 180 can extend from the tub 102 and/or the upper frame 120, for example, and the base 104 can include one or more lock down holes 104.

While several embodiments of the invention have been described, it should be apparent, however, that various modifications, alterations and adaptations to those embodiments may occur to persons skilled in the art with the attainment of some or all of the advantages of the present invention. It is therefore intended to cover all such modifications, alterations and adaptations without departing from the scope and spirit of the present invention as defined by the appended claims.

What is claimed is:

1. A material handling device comprising:
a base frame, wherein the base frame comprises:
at least one first tube configured to receive a support member from a vehicle, wherein the first tube extends in a first direction; and
at least one second tube configured to receive a support member from a vehicle, wherein the second tube extends in a second direction which is different than the first direction; and
a dump body, wherein the dump body is configured to be hingedly connected to the base frame.

2. The material handling device of claim 1, wherein the first direction is perpendicular to the second direction.

3. The material handling device of claim 1, wherein the first direction is transverse to the second direction.

4. The material handling device of claim 1, wherein the first tube includes a first opening at a first end and a second opening at a second end, and wherein the support member can be inserted into the first tube from either end.

5. The material handling device of claim 1, wherein the second tube includes a first opening at a first end and a second opening at a second end, and wherein the support member can be inserted into the second tube from either end.

6. The material handling device of claim 1, wherein the base frame further comprises an additional first tube and two longitudinal members.

7. The material handling device of claim 6, further comprising an actuator, wherein at least a portion of the actuator is positioned within an actuation system area defined by the two longitudinal members and the two first tubes.

8. The material handling device of claim 7, further comprising a pump in fluid communication with the actuator, wherein at least a portion of the pump is positioned within the actuation system area.

9. The material handling device of claim 8, further comprising a reservoir configured to remotely store a quantity of fluid, wherein the reservoir is in fluid communication with the pump such that the pump can draw the fluid from the reservoir, and wherein at least a portion of the reservoir is positioned within the actuation system area.

10. The material handling device of claim 7, further comprising a power source configured to operate the pump, wherein at least a portion of the power source is positioned within the actuation system area.

11. The material handling device of claim 7, further comprising a control source configured to operate the pump, wherein the control source is configured to be operated remotely.

12. The material handling device of claim 1, wherein the base frame includes at least one aperture configured to receive a locking pin for mounting the base frame to the bed of a vehicle.

13. The material handling device of claim 1, wherein the base frame further comprises a lockdown assembly configured to mount the material handling device to the bed of a vehicle.

14. A material handling device comprising:
a base frame, wherein the base frame comprises:
at least two longitudinal members; and
at least two tubes configured to receive a support member from a vehicle;
a dump body, wherein the dump body is configured to be hingedly connected to the base frame;
an actuator, wherein at least a portion of the actuator is positioned within an actuation system area defined by the longitudinal members and the tubes;
a pump in fluid communication with the actuator, wherein at least a portion of the pump is positioned within the actuation system area; and
a reservoir configured to remotely store a quantity of fluid, wherein the reservoir is in fluid communication with the pump such that the pump can draw the fluid from the reservoir, and wherein at least a portion of the reservoir is positioned within the actuation system area.

15. The material handling device of claim 14, further comprising a power source configured to operate the pump, wherein at least a portion of the power source is positioned within the actuation system area.

16. The material handling device of claim 14, further comprising a control source configured to operate the pump, wherein the control source is configured to be operated remotely.

17. The material handling device of claim 14, wherein said at least two tubes comprise at least two first tubes, and wherein the base frame further comprises at least one second tube.

18. The material handling device of claim 17, wherein at least one of the first tubes extends in a first direction, and wherein the second tube extends in a second direction which is different than the first direction.

19. The material handling device of claim 18, wherein the first direction is perpendicular to the second direction.

20. The material handling device of claim 18, wherein the first direction is transverse to the second direction.

21. A material handling device comprising:
a base frame comprising:
at least one tube configured to receive a support member from a vehicle; and
a first hinge portion;
a dump body comprising a second hinge portion hingedly connected to the first hinge portion, wherein the hinged connection allows the dump body to be moved from a non-dumping position to a dumping position; and
at least one lifting lug.

22. The material handling device of claim 21, further comprising a locking mechanism for locking the dump body to the base frame when the dump body is in the non-dumping position.

23. The material handling device of claim 21, wherein the tube includes a first opening at a first end and a second opening at a second end, wherein the support member can be inserted into the tube from either end.

24. The material handling device of claim 21, wherein the base frame includes at least one aperture configured to receive a locking pin for mounting the base frame to the bed of a vehicle.

25. A material handling device comprising:
a base frame, wherein the base frame comprises at least one tube configured to receive a support member from a vehicle; and
a dump body, wherein the dump body is configured to be hingedly connected to the base frame.
